(19) United States
(12) Patent Application Publication
(10) Pub. No.: US 2017/0360176 A1
(43) Pub. Date: Dec. 21, 2017

(54) SEALING STRUCTURE OF CREAM-TYPE COSMETICS CONTAINER

(71) Applicant: YONWOO CO., LTD., Incheon (KR)

(72) Inventors: Hak-Chan Kim, Incheon (KR); Shin-Bok Jung, Incheon (KR)

(21) Appl. No.: 15/529,191

(22) PCT Filed: Oct. 13, 2015
(86) PCT No.: PCT/KR2015/010759

§ 371 Date: May 24, 2017

(30) Foreign Application Priority Data
Dec. 2, 2014 (KR) 10-2014-0170551

(51) Int. Cl. A45D 40/00; A45D 40/22; B05B 11/00

(52) U.S. Cl. CPC A45D 40/0075; B05B 11/0072; B05B 11/007; A45D 40/22; B05B 11/0048; A45D 2200/054

(57) ABSTRACT

A sealing structure of a cream-type cosmetics container is disclosed, the sealing structure having an elastic protrusion formed to be bent and brought into close contact with a mounting groove when a pressurizing part, provided at the inner upper side of a finishing cap, makes contact with the upper end surface of a pumping guide cap during a process of coupling the finishing cap to a container body, thereby performing an efficient sealing function as the volume of a space formed by the pumping guide cap and the finishing cap is being reduced and pressure therein is increasing, and preventing a first valve member from opening a contents discharge hole, and in addition, preventing the leakage of contents even if the internal pressure of the container body increases.

### TECHNOLOGICAL FIELD

The present disclosure relates to a sealing structure of a cream-type cosmetics container.

### BACKGROUND

In general, a cream-type cosmetics container storing high-viscosity cream is configured to prevent contents received in a cosmetics container from being exposed to air. This cream-type cosmetics container is disclosed in the registered patent no. 10-1453048.

The registered patent includes: a container body receiving contents, and having a volume thereof getting reduced according to use of contents; a pumping guide cap coupled to an upper portion of the container body, elastically deformed by user's pressurization, and discharging the contents received in the container body by pumping operation; and a contents absorption part coupled at an inner side of the container body as forming a space storing contents at a lower portion of the pumping guide cap, and absorbing a fixed amount of contents stored in the container body by an elastic deformation of the pumping guide cap, wherein the pumping guide cap is characterized to include a button part, made of an elastic material, which is disposed at one side of an upper end of the pumping guide cap and guides pumping operation by changing pressure of the space formed by the pumping guide cap and the contents absorption member by an elastic deformation in which a upper surface thereof moves to a downward direction and then is restored according to user's pressurization; and a discharge hole disposed at the other side of an upper end of the pumping guide cap and discharging contents by manipulation of the button part.

The registered patent is configured in a way that contents pass through a contents discharge hole during a pumping operation through the button part and are discharged onto an upper surface of the pumping guide cap, such that a pressing protrusion formed at an inner upper side of the finishing cap presses an upper end of the pumping guide cap and prevents the pumping guide cap from being separated from the container body in a normal state that the finishing cap is coupled to an upper portion of the container body.

However, since the pressing protrusion having a structure of simply pressing an upper end of the pumping guide cap does not have a perfect sealing function for blocking the air movement in case the inner pressure of the container body rises, there arises a problem of contents leaking through a content discharge hole.

### SUMMARY

The present disclosure is provided to solve the above mentioned problem, and the present disclosure is to provide a sealing structure of a cream-type cosmetics container having an elastic protrusion bent and brought into close contact with a mounting groove when a pressurizing part, provided at the inner upper side of a finishing cap, makes contact with the upper end surface of a pumping guide cap during a process of coupling the finishing cap to a container body, thereby performing an efficient sealing function as the volume of a space formed by the pumping guide cap and the finishing cap is reduced and pressure is getting increased and also preventing a first valve member from opening a contents discharge hole, thus preventing the leakage of contents even if the internal pressure of the container body increases.

To solve the above-described problems, a sealing structure of a cream-type cosmetics container according to a first exemplary embodiment includes: a container body which forms a first space where contents are stored and has a volume thereof getting reduced according to usage of contents; a pumping guide cap which is coupled to an upper portion of the container body and forms a contents discharge hole at an upper end thereof for discharging contents stored in the container body by the pumping operation according to user's manipulation; and a finishing cap which encases the pumping guide cap and is coupled to an upper portion of the container body, and is provided with a pressurizing part which presses an upper end of the pumping guide cap at an inner upper side thereof,

characterized in that at an upper end of the pumping guide cap is formed a mounting groove where the pressurizing part is mounted, and at a lower portion of the pressurizing part is provided an elastic protrusion which is bent when mounted on the mounting groove, such that the elastic protrusion is bent when the elastic protrusion mounts on the mounting groove in a process of coupling the finishing cap to the container body and thereby preventing air from moving while the elastic protrusion is being bent and contacted to the mounting groove.

Furthermore, it is characterized in that a first valve member, opening/closing the contents discharge hole, is prevented from opening by the inner pressure of a second space arising as the second space formed by the pumping guide cap and the finishing cap becomes decreasing as much as the elastic protrusion is bent in a process of coupling the finishing cap to the container body.

Meanwhile, a sealing structure of a cream-type cosmetics container according to a second exemplary embodiment includes: a container body which forms a first space where contents are stored and has a volume thereof getting reduced according to usage of contents; a pumping guide cap which is coupled to an upper portion of the container body and forms a contents discharge hole at an upper end thereof for discharging contents stored in the container body by the pumping operation according to user's manipulation; a finishing cap, which encases the pumping guide cap and is coupled to an upper portion of the container body, is provided with a receiving groove which receives an upper end of the pumping guide cap at a upper portion thereof and a pressurizing part which presses an upper end of the pumping guide cap at an lower portion thereof; and an over cap encasing the contents application member and hinge-coupled to the container body for being rotated upwards and downwards,

characterized in that at an upper end of the pumping guide cap is formed a mounting groove where the pressurizing part is mounted, and at a lower portion of the pressurizing part is provided an elastic protrusion which is bent when mounted on the mounting groove, such that the elastic protrusion is bent when the elastic protrusion is mounted on the mounting groove in a process of coupling the finishing cap to the pumping guide cap and thereby preventing air from moving while the elastic protrusion is being bent and contacted to the mounting groove.

Furthermore, it is characterized in that a first valve member, which opens/closes the contents discharge hole, in a process of coupling the finishing cap to the container body, is prevented from being opened by the inner pressure of a second space arising that is generated as the volume of the second space formed by the pumping guide cap and the finishing cap is getting decreased as much as the elastic protrusion is bent, such that contents are prevented from being discharged through the contents discharge hole.

As described in the above, a sealing structure of a cream-type cosmetics container is configured in a way that an elastic protrusion is bent and brought into close contact with a mounting groove when a pressurizing part provided at an inner upper side of the finishing cap meets an upper end surface of the pumping guide cap in a process of coupling the finishing cap to a container body, such that an efficient sealing function is achieved as the volume of a space formed by the pumping guide cap member and the finishing cap is decreasing and the pressure is rising. In addition, since a first valve member can stop the contents discharge hole from opening, it is also possible to prevent the leakage of contents even if the internal pressure of the container body increases

### BRIEF DESCRIPTION OF THE FIGURES

FIG. 1 is an exploded cross-sectional view illustrating a configuration of a sealing structure of a cream-type cosmetics container according to a first exemplary embodiment.

FIG. 2 is an assembled cross-sectional view illustrating a configuration of a sealing structure of a cream-type cosmetics container according to a first exemplary embodiment.

FIGS. 3(a) and 3(b) are views illustrating an operational state of a sealing structure of a cream-type cosmetics container according to a first exemplary embodiment.

FIGS. 4 is an assembled cross-sectional view illustrating a configuration of a sealing structure of a cream-type cosmetics container according to a second exemplary embodiment.

FIGS. 5(a) and 5(b) are views illustrating an operational state of a sealing structure of a cream-type cosmetics container according to a second exemplary embodiment.

### DETAILED DESCRIPTION

Hereinafter, the embodiments will be described in detail with reference to the accompanying drawings. The same reference numerals provided in the drawings indicate the same members.

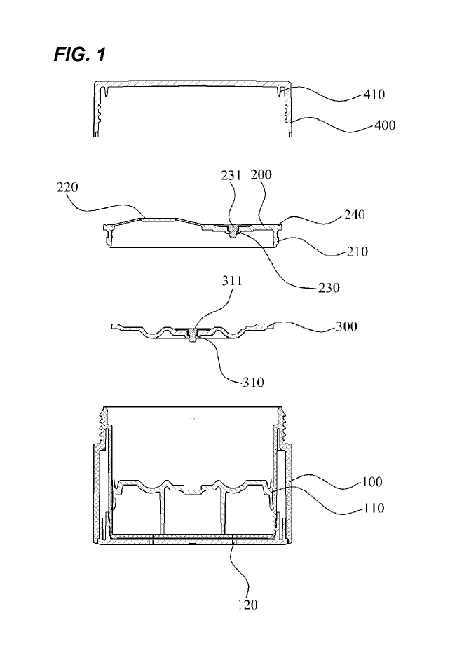

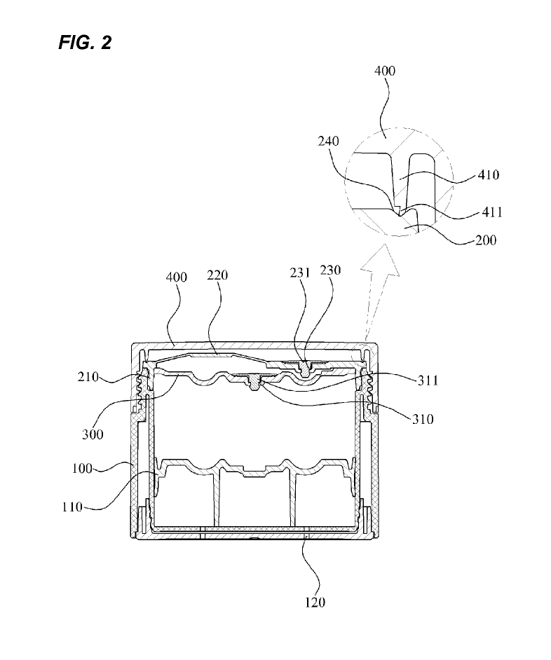

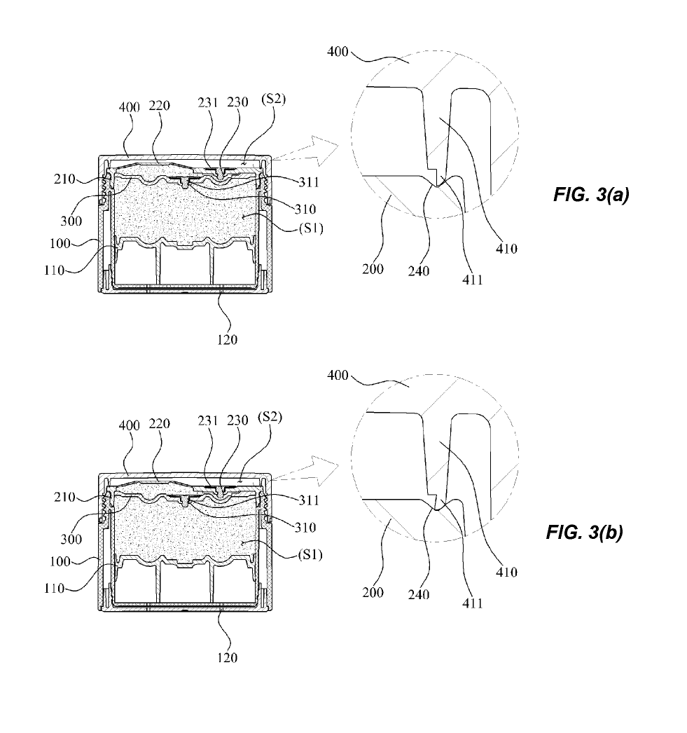

FIG. 1 is an exploded cross-sectional view illustrating a configuration of a sealing structure of a cream-type cosmetics container according to a first exemplary embodiment. FIG. 2 is an assembled cross-sectional view illustrating a configuration of a sealing structure of a cream-type cosmetics container according to a first exemplary embodiment. FIGS. 3(a) and 3(b) are views illustrating an operational state of a sealing structure of a cream-type cosmetics container according to a first exemplary embodiment.

Referring to FIGS. 1 and 3(a) and 3(b), a sealing structure of a cream-type cosmetics container according to a first exemplary embodiment includes a container body 100, a pumping guide cap 200, and a finishing cap 400.

The container body 100, receiving contents, is provided, at an interior thereof, with a piston 110 which ascends according to contents use.

At a lower end of the container body 100 is provided an air inflow hole 120 such that air can flow into the inside of the container body 100 when the piston 110 ascends with pumping operation by controlling a pumping guide cap 200 to be described later.

The pumping guide cap 200 is coupled to an upper portion of the container body and closes an upper end opening of the container body 100, further including a coupling part 210 coupled to an upper portion of the container body 100 for fixing the pumping guide cap 200 to an upper portion of the container body 100.

At one side of an upper end of the pumping guide cap 200 is provided a button part 220 which is elastically deformed according to user's pressurization and changes the pressure of a space formed by the contents absorption part 300 and a pumping guide cap 200 to be described later, thereby discharging contents absorbed into the contents absorption part 300 to the outside, wherein the button part 220, an entire upper surface of which moves downwards when a user presses an upper end thereof and then restores when the user releases the upper end thereof, guides a pumping operation by changing the pressure of the space formed by the contents absorption part 300 and a pumping guide cap 200. In addition, the button part 220 is made of an elastic material for being able to be elastically deformed according to user's pressurizing.

Meanwhile, a contents discharge hole 230 is provided at an upper end of the pumping guide cap 200 such that contents can be discharged by pumping operation according to the control of the button part 220, wherein at the contents discharge hole 230 is provided a first valve member 231 which opens/closes the contents discharge hole 230 according to the pressurization of the button part 220.

The present embodiments are characterized in a way that a mounting groove 240, where a pressurizing part 410 of the finishing cap 400 is mounted, is provided at an upper end of the pumping guide cap 200, wherein the mounting groove 240 is contacted with an elastic protrusion 411 of the pressurizing part 410 and preferably has a shape corresponding to the shape of the elastic protrusion 411 for being able to block air inflow.

The contents absorption part 300, which is coupled to a lower portion of the pumping guide cap 200 at an inner side of the container body 100 and absorbs a fixed amount of contents stored in the container body 100 by an elastic deformation of the button part 220 of the pumping guide cap 200, forms a space separated with a predetermined distance from the pumping guide cap 200 at a lower portion of the pumping guide cap and stores contents for absorbing and storing the contents stored in the container body 100.

Furthermore, a contents inflow hole 310 is provided at the contents absorption part 300 such that contents stored in the container body 100 can flow in, wherein at the contents inflow hole 310 is formed a second valve member 311 which opens/closes the contents inflow hole 310 according to pressurization of the button part 220.

The contents absorption part 300, by absorbing and storing a fixed amount of contents received in the container body 100, guides to always discharge a fixed amount of contents by a pumping operation according to the control of the button part 220.

The finishing cap 400, encasing the pumping guide cap 200 and coupled to an upper portion of the container body 100, prevents the button part 220 from malfunctioning and the first valve member 231 from being broken from an exterior impact.

At an upper inner side of the finishing cap 400 is provided a pressurizing part 410 which presses an upper end of the pumping guide cap 200 for preventing the pumping guide cap 200 from being separated from the container body 100. The present embodiments are characterized in that an elastic protrusion 411, bent when mounted at the mounting groove 240, is provided at a lower portion of the pressurizing part 410.

The elastic protrusion 411, which is made of an elastic material and thus, can be bent when meeting the mounting groove 240 in a process of coupling the finishing cap 400 to the container body 100, is bent when mounted at the mounting groove 240 and performs a sealing function by preventing air from flowing into a second space (S2) formed by the pumping guide cap 200 and the finishing cap 400 as the elastic protrusion 411 gets bent and contacted to the mounting groove 240 when mounted to the mounting groove 240.

Describing more in detail with a reference of FIGS. 3(a) and 3(b), when the finishing cap 400 is coupled to the container body 100, the elastic protrusion 411 finishes being mounted to the mounting groove 240 before completing screw-coupling. If a finishing cap 400 rotates one more time at this state, the elastic protrusion 411 bends and gets to be contacted to a mounting groove 240 at the time when the finishing cap 400 completes a screw coupling with the container body 100.

As in the above, when the elastic protrusion 411 bends and gets to be contacted to the mounting groove 240, the volume of a second space (S2) formed by the pumping guide cap 200 and the finishing cap 400 decreases as much as the elastic protrusion bends. Pressure is applied to a first valve member 231, which opens/closes the contents discharge hole 230 by the inner pressure of the second space (S2) generated due to this, and thereby the first valve member 231 is prevented from opening, such that it is possible to prevent leakage of contents through the contents discharge hole 230 even though the pressure of the first space (S1) where contents are stored rises.

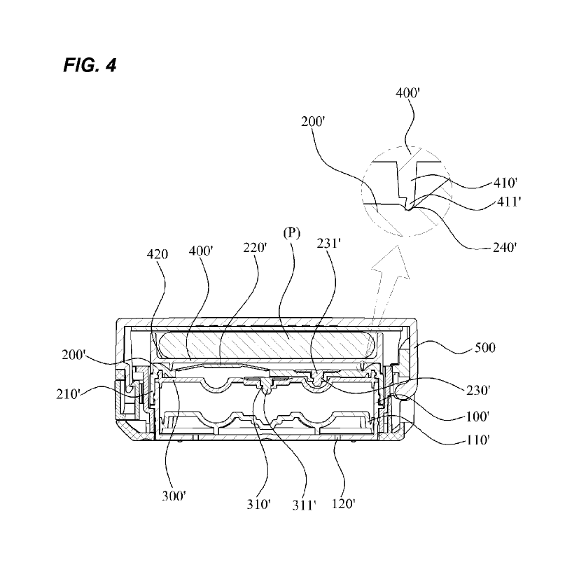

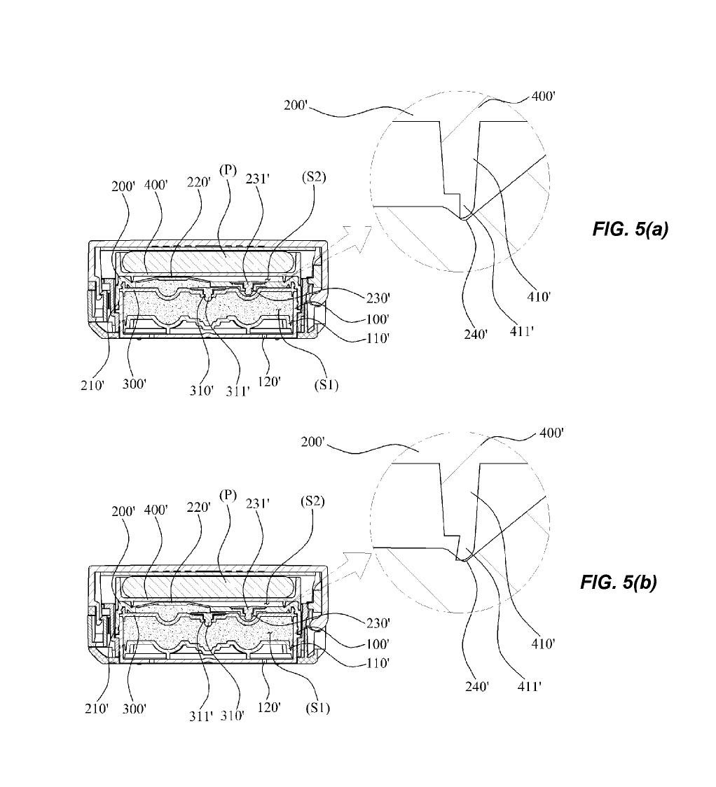

Hereinafter, referring FIGS. 4 to 5(b), a sealing structure of a cream-type cosmetics container according to a second exemplary embodiment will be explained. FIGS. 4 is an assembled cross-sectional view illustrating a configuration of a sealing structure of a cream-type cosmetics container according to a second exemplary embodiment. FIG. 5 is a view illustrating an operational state of a sealing structure of a cream-type cosmetics container according to a second exemplary embodiment.

Referring to FIGS. 4 to 5(b), a sealing structure of a cream-type cosmetics container according to a second exemplary embodiment includes a container body 100′, a pumping guide cap 200′, a contents absorption part 300′, a finishing cap 400′, and an over cap 500′. Since each structure comprising a container body 100′, a pumping guide cap 200′, and a contents absorption part 300′ are the same with the structure and function thereof according to the first exemplary embodiment, hereafter will be described a structural difference of the finishing cap 400′.

The finishing cap 400′ encasing the pumping guide cap 200′ and coupled to an upper portion of the pumping guide cap 200′ is provided with a receiving groove 420 which receives a contents application member (P), such as a puff, at an upper portion thereof, and a pressurizing part 410′ which pressurizes an upper end of the pumping guide cap 200′ so as to prevent the pumping guide cap 200′ from being separated from the container body 100′. In the present embodiments, it is characterized that at a lower portion of the pressurizing part 410′ is provided an elastic protrusion 411′ which bends when mounted on the mounting groove 240′.

In case the elastic protrusion 411′ meets the mounting groove 240′, in a process of coupling a finishing cap 400 to the pumping guide cap 200′, that is, in a process of rotating the finishing cap 400 opened by rotating to an upper portion to the downward direction, the elastic protrusion 411′ made of elastic material is bent. When mounted at a mounting groove 240′, the elastic protrusion 411′ is bent, and as getting contacted to the mounting groove 240′, the elastic protrusion 411′ prevents air from flowing into a second space (S2) formed by the pumping guide cap 200′ and the finishing cap 400′ and performing a sealing function.

To describe in detail, referring to FIGS. 5(a) and 5(b), when the finishing cap 400′ is rotated to a downward direction and coupled to the pumping guide cap 200′, the elastic protrusion 411′ gets mounted to the mounting groove 240′ before the coupling is completed. In this state, if the finishing cap 400′ is moved to the dead end in a downward direction, the elastic protrusion 411′ bends and gets contacted to the mounting groove 240′ at the time that the finishing cap 400′ finishes coupling to the pumping guide cap 200′.

When the elastic protrusion 411′ bends and gets contacted to the mounting groove 240′ as in the above, the volume of the second space (S2) formed by the pumping guide cap 200′ and the finishing cap 400′ decreases as much as the elastic protrusion 411′ bends. By the inner pressure of the second space (S2) generated due to this, pressure is delivered to a first valve member 231′ opening/closing a contents discharge hole 230′ and thereby prevents the first valve member 231′ from opening; hence, though the pressure of the first space (S1) rises, it is possible to prevent contents from leaking through the contents discharge hole 230′.

In other words, the present embodiments are disclosed as a cosmetic container having a structure that contents are discharged to an upper end of the pumping guide cap 200, 200′ by a pumping operation, wherein the finishing cap 200, 200′ is able to prevent air from moving by sealing the space (S2) formed by the pumping guide cap 200, 200′ and the finishing cap 400, 400′ in a state of closing the upper portion of the pumping guide cap 200, 200′, such that contents can be prevented from leaking through the contents discharge hole 230, 230′ even though the pressure of the first space (S1) storing contents rises.

As described above, optimal embodiments have been disclosed in the drawings and the specification. Although specific terms have been used herein, these are only intended to describe the contemplated embodiments and are not intended to limit the meanings of the terms or to restrict the scope of the accompanying claims. Therefore, those skilled in the art will appreciate that various modifications and other equivalent embodiments are possible from the above embodiments.

What is claimed is:

1. A sealing structure of a cream-type cosmetics container, the sealing structure comprising:
a container body forming a first space where contents are stored and having a volume thereof getting reduced according to contents use;
a pumping guide cap coupled to an upper portion of the container body and provided with a contents discharge hole at an upper end thereof for discharging contents stored in the container body by pumping operation according to user's manipulation; and
a finishing cap, encasing the pumping guide cap and coupled to an upper portion of the container body, further comprising a pressurizing part pressing an upper end of the pumping guide cap at an inner upper side thereof,
wherein at an upper end of the pumping guide cap is provided a mounting groove where the pressurizing part is mounted, and at a lower portion of the pressurizing part is provided an elastic protrusion which is bent when mounted on the mounting groove, such that the elastic protrusion is bent when the elastic protrusion is mounted on the mounting groove in a process of coupling the finishing cap to the container body and thereby prevents air from moving while the elastic protrusion is being bent and closely contacted to the mounting groove.

2. A sealing structure of a cream-type cosmetics container, the sealing structure comprising:
a container body forming a first space where contents are stored and having a volume thereof getting reduced according to usage of contents;
a pumping guide cap coupled to an upper portion of the container body and forming a contents discharge hole at an upper end thereof for discharging contents stored in the container body by pumping operation according to user's manipulation;
a finishing cap, encasing the pumping guide cap and coupled to an upper portion of the container body, provided with a receiving groove which receives an upper end of the pumping guide cap at an upper portion thereof and a pressurizing part which presses an upper end of the pumping guide cap at a lower portion thereof; and
an over cap encasing the contents application member and hinge-coupled to the container body for being rotated upwards and downwards,
wherein at an upper end of the pumping guide cap is provided a mounting groove where the pressurizing part is mounted, and at a lower portion of the pressurizing part is provided an elastic protrusion which is bent when mounted on the mounting groove, such that the elastic protrusion is bent when the elastic protrusion is mounted on the mounting groove in a process of coupling the finishing cap to the pumping guide cap and thereby prevents air from moving while the elastic protrusion is being bent and contacted to the mounting groove.

3. The sealing structure of claim 1,
wherein a first valve member, opening/closing the contents discharge hole, is prevented from opening by an inner pressure of a second space generated as the second space formed by the pumping guide cap and the finishing cap becomes decreasing as much as the elastic protrusion is bent in a process of coupling the finishing cap to the container body.

4. The sealing structure of claim 2,
wherein a first valve member, opening/closing the contents discharge hole in a process of coupling the finishing cap to the container body, is prevented from being opened by an inner pressure of a second space generated as the volume of the second space formed by the pumping guide cap and the finishing cap is getting decreased as much as the elastic protrusion is bent, such that contents are prevented from being discharged through the contents discharge hole.
